(19) United States
(12) Patent Application Publication
(10) Pub. No.: US 2020/0202729 A1
(43) Pub. Date: Jun. 25, 2020

(54) SYSTEM FOR AUTONOMOUS UNMANNED AERIAL VEHICLE TRAJECTORY CONFLICT RESOLUTION

(71) Applicants: William Tam, San Marino, CA (US); Sahithya M. Prakash, Saratoga, CA (US); Max Z. Li, Champaign, IL (US); John F. Kearney, Philadelphia, PA (US)

(72) Inventors: William Tam, San Marino, CA (US); Sahithya M. Prakash, Saratoga, CA (US); Max Z. Li, Champaign, IL (US); John F. Kearney, Philadelphia, PA (US)

(21) Appl. No.: 16/228,592

(22) Filed: Dec. 20, 2018

(51) Int. Cl. G08G 5/04; G08G 5/00; B64C 39/02

(52) U.S. Cl. CPC G08G 5/04; G08G 5/0069; B64C 2201/141; B64C 39/024; G08G 5/0043

(57) ABSTRACT

A system for controlling flight paths of a plurality of autonomous unmanned aerial vehicles (aUAVs) is provided. The system includes a control module within a region comprising a receiver-transmitter configured to receive waypoint information from aUAVs entering the region and transmit navigation commands to each aUAV in the region, and one processing element added to and provided with one aUAV configured to enter the region, the one processing element configured to transmit waypoint information for a desired path for the one aUAV through at least one waypoint in the region to the control module. The control module is configured to transmit a first command to the one processing element of a lower priority aUAV in case of a path conflict in the region between the lower priority aUAV and a higher priority aUAV and a second command to the lower priority aUAV upon resolution of the path conflict.

### BACKGROUND

### I. Field

The present invention relates generally to autonomous unmanned aerial vehicles (aUAVs), and more specifically, to controlling aUAVs in low altitude, high density airspace.

### II. Background

Autonomous unmanned aerial vehicles (aUAVs) present enormous societal and economic benefits with their potential to carry out missions such as the delivery of medical supplies and food, search-and-rescue operations, agricultural functions, and industrial surveillance. One critical safety issue encountered with such devices is the potential for trajectory conflicts within complex low-altitude, high-density (LAHD) airspace. Currently, aUAVs do not have the capabilities to avoid other aUAVs with a high degree of certainty within this LAHD airspace. This presents safety risks that hinder the large-scale adoption of aUAVs.

Various government entities are concerned with deployment of aUAVs and the risks associated therewith, and the possibility of aUAV-on-aUAV mid-air collisions prevent aUAV operations from being adopted en masse. The issue tends to be one similar to air traffic control, which involves manned aircraft, but remains one of trajectory—aircraft X can typically traverse airspace with aircraft Y if both are at different altitudes or vectors that will not result in collision or even near misses.

Current methods employed to resolve aircraft trajectory conflicts for aUAVs involve individual aUAVs using their onboard sensors in an attempt to sense and avoid other objects. This is similar to the see and sense method used by human pilots in commercial and military aircraft but can be inadequate for aUAVs. This decentralized approach is difficult to scale, both in terms of onboard sensing hardware and software as well as energy consumption. Such sensors are expensive and can have difficulty sensing and identifying all potential threats.

The result has been to restrict adoption of aUAVs. Restrictions placed on aUAVs stem from both fear of collisions and an inability to determine whether the “sense-and-avoid” method of aUAVs is adequate for aUAVs. Namely, there are concerns by various entities as to whether aUAVs are capable of yielding to other aUAVs, aircraft, and obstacles in the same airspace.

Such concerns related to aUAV collisions are not unfounded—while higher-end models have collision detection and resolution capabilities for large, static objects like walls, no aUAV has avoidance capabilities for small or mobile objects. Mid-air collisions jeopardize the aUAV mission and its payload and create the potential for damage to the aUAV and potential harm to property or, in extreme cases, injury to bystanders below resulting from falling debris.

Security is also an issue with aUAVs. Abilities to sabotage or hack these devices are of concern, and privacy considerations need to be weighed when controlling aUAVs.

It would be beneficial to provide an aUAV control system that improves over previous designs. Additionally, communications with aUAVs require protocols that operate within bandwidths approved and controlled by the FCC (Federal Communications Commission) and control must be compatible with federal regulations, such as those promulgated by the FAA (Federal Aviation Administration) and other relevant governmental bodies (Federal, State, local, and potentially international).

### SUMMARY

According to the present design, there is provided a system for controlling flight paths of a plurality of autonomous unmanned aerial vehicles (aUAVs), comprising a control module located within a region, the control module comprising a receiver-transmitter configured to receive waypoint information from aUAVs entering the region and transmit navigation commands to each aUAV in the region, and one processing element added to and provided with one aUAV configured to enter the region, the one processing element added to and provided with the one aUAV configured to transmit waypoint information for a desired path for the one aUAV through at least one waypoint in the region to the control module. The control module is configured to transmit a first command to the one processing element of a lower priority aUAV in case of a path conflict in the region between the lower priority aUAV and a higher priority aUAV and a second command to the lower priority aUAV upon resolution of the path conflict.

According to another aspect of the present design, there is provided a system for controlling autonomous unmanned aerial vehicles (aUAVs), comprising a control module located within a region, the control module comprising a receiver-transmitter configured to receive waypoint information from aUAVs entering the region and transmit select navigation commands to select aUAVs in the region, and one processing element added to and provided with one aUAV configured to enter the region, the one processing element configured to transmit waypoint information for a desired path for the one aUAV through at least one waypoint in the region to the control module. The control module is configured to determine conflicts between aUAV paths and transmit a first command to the one processing element of a lower priority aUAV in case of a path conflict in the region between the lower priority aUAV and a higher priority aUAV and a second command to the lower priority aUAV upon resolution of the path conflict.

According to a further embodiment, there is provided a system for controlling autonomous unmanned aerial vehicles (aUAVs), comprising a control module located within a region, the control module configured to receive waypoint information from aUAVs entering the region and transmit select navigation commands to select aUAVs in the region, and one processing element added to and provided with one aUAV configured to enter the region, the one processing element configured to transmit waypoint information for a desired path for the one aUAV through at least one waypoint in the region to the control module. The control module is configured to transmit a first command to the one processing element of a lower priority aUAV in case of a path conflict in the region between the lower priority aUAV and a higher priority aUAV and a second command to the lower priority aUAV upon resolution of the path conflict.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

These and other features, aspects, and advantages of the present invention will become better understood with regard to the following description, appended claims, and accompanying drawings where:

FIG. 1 is an overall system flowchart according to the present design;

FIG. 2 illustrates two vehicles coming into contact while traversing their routes;

FIG. 3 shows two aUAVs on potentially conflicting missions;

FIG. 4A shows post-waypoint processing where trajectory conflict search is performed through voxel reservations;

FIG. 4B illustrates an impeding conflict triggering a hold or hold-in-place command;

FIG. 5 is a system flowchart showing the processes and decisions related to communications between the aUAV and the control module;

FIG. 6 is a top-down view of a mission including waypoints;

FIG. 7 shows items interfacing with the control module to effectuate the current design;

FIG. 8 represents communication command script between the control module and the aUAV requesting a reservation, written in MATLAB;

FIG. 9 shows centering on the control module and transformation of global latitude-longitude coordinates to local Cartesian coordinates;

FIG. 10 illustrates three-dimensional spline trajectories parameterized in time;

FIG. 11 shows “thickened” spline trajectories with tubular error neighborhoods;

FIG. 12 is a hypothetical three aUAV traversal of a region or reservation space, including point representations of the aUAVs, as well as representations of voxels and paths;

FIG. 13 shows “thickened” spline trajectories assigned voxel reservation sets;

FIG. 14 illustrates searching for intersection between two voxel reservation sets; and

FIG. 15 shows detection of an intersection between paths based on voxel overlap.

### DETAILED DESCRIPTION

The present design provides a system for centrally controlling aUAVs that takes into account restrictions and the requirements to accurately and efficiently provide such control. The centralized system employs a series of transmitters that are employed in a given region, where the system determines a series of waypoints and controls the aUAVs along such determined waypoints using the transmitters with minimal risk of collision. The system determines a preferable path, including error, for each aUAV and in certain situations provides one or more commands for a given aUAV to stop and maintain its position, such as by hovering, such that at least one different aUAV may continue along its path.

The design provided employs a centralized, infrastructure-to-vehicle (I2V) approach that leverages modular embedded systems (“control modules”) acting as air traffic controllers for a specific sector of the airspace utilized by aUAVs. A voxel-based airspace reservation system is provided and maintained by a centralized control module. The control module interrogates and retrieves the stored trajectories from aUAVs approaching the reservation airspace. The control module performs a trajectory conflict search, and the system transmits conflict resolution protocols to the aUAVs. One communication protocol is based on XBee and can be integrated with a large range of aUAV flight controllers via a lightweight on-board microcontroller. The centralized and scalable traffic control system for aUAVs serves as a technological framework addressing current restrictions on aUAV operations.

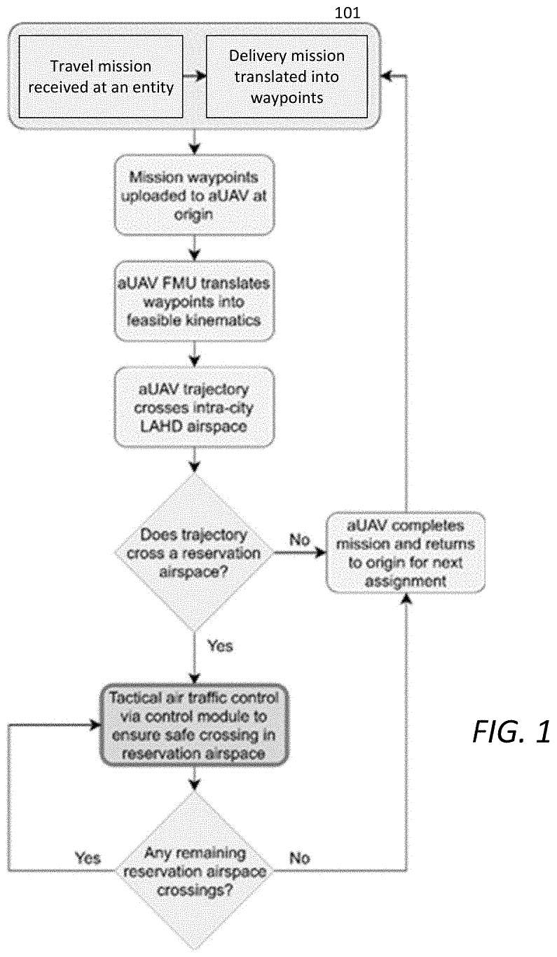

The overall system flowchart is provided in FIG. 1. From FIG. 1, the system initiates a route at point 101, including a travel mission being received at an entity at point 102, and potentially translating that travel mission into appropriate form, such as GPS coordinates, cartesian coordinates, or any other high level semantic translation necessary for subsequent processing. At point 103, the system may have received or may maintain a physical map of an area near or around the proposed path and may generate a series of waypoints. As may be appreciated, a minimal number of waypoints may be generated by the system for a simple path with minimal obstructions, while a more complex path, such as over hills or even mountains, with telephone lines, trees, buildings, or other obstructions, may require multiple waypoints. In one instance, the system may assess the desired route or travel mission and compare the travel mission against the known terrain and may determine a number N of waypoints. At point 104, the system provides the waypoints to the aUAV at its origin location. At point 105, the FMU (flight management unit) of the aUAV may translate the various waypoints into feasible kinematics. The aUAV may begin traversing the waypoints. At point 106, the aUAV trajectory crosses into LAHD (low altitude, high density) airspace. Point 107 calls for a determination as to whether the trajectory of the aUAV crosses a reservation airspace, i.e. airspace where another route exists. If the answer is no, point 108 calls for the aUAV to complete its mission and potentially to return to its origin for a next assignment. In a typical scenario, the aUAV will follow the waypoints backward to the origin. It should be noted that conditions on the return trip may change from the conditions when the aUAV originally traversed the waypoints. However, the system provides priority to an aUAV on a return trip, and if other aUAVs are set to traverse the area, the system will alter their routes as described herein. Thus if the aUAV is to traverse an area over a determined route, the system permits that same aUAV to return to its origin via the same waypoints.

If the trajectory of the aUAV crosses reserved airspace, the system operates according to point 109, where the system provides tactical air traffic control to ensure safe crossing into reservation airspace. Such tactical air traffic control is discussed below. At this point, the system transitions to point 110, wherein the system determines whether any reservation airspace crossings remain. If so, tactical air traffic control is performed according to point 109, but if not, the aUAV completes its mission and returns to its origin according to point 108. Once returned to its origin, the aUAV begins the procedure again at point 101.

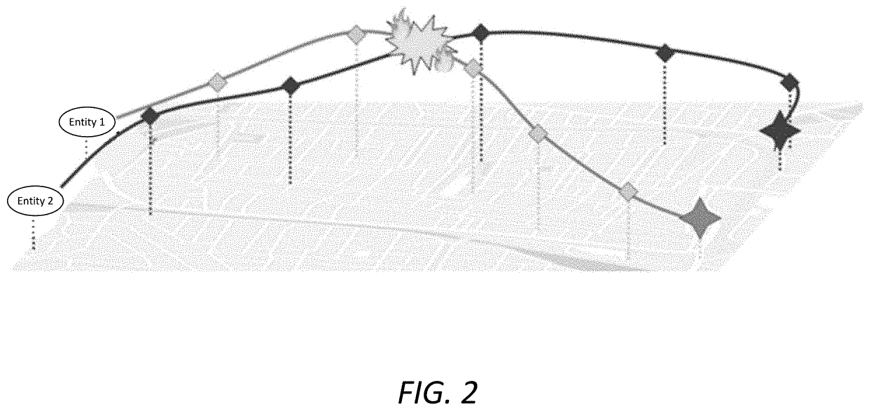

One issue resolved by the present design is that of two vehicles coming into contact while traversing their routes. FIG. 2 illustrates an example of such a scenario. From FIG. 2, a first aUAV begins at origin 1 201 and seeks to travel to destination 1 202, using waypoints 203a, 203b, 203c, and 203d. Similarly, second aUAV begins at origin 2 204 and is routed by the system to destination 2 205 via waypoints 206a, 206b, 206c, 206d, and 206e. These two conflicting missions represent a trajectory conflict.

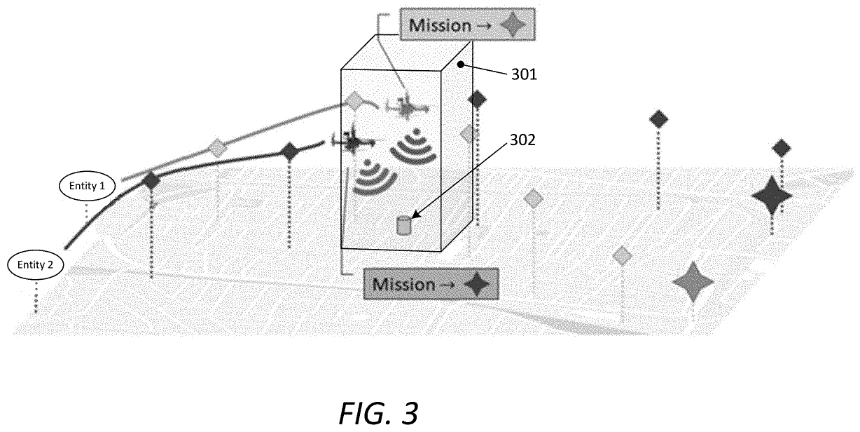

The system is deployed throughout the LAHD traversable airspace as modular embedded systems, called control modules herein. Each control module projects or considers a reservation airspace of a particular dimension around itself. The reservation airspace, also called the region, is represented as reservation airspace 301 surrounding control module 302 in FIG. 3. If an aUAV mission requires passage through the reservation airspace of a given control module, the aUAV contacts the control module in that region and transmits its mission in terms of waypoints to the control module 302.

Upon receiving the two potentially conflicting missions from aUAVs, the control module 302 performs coordinate transformations on the waypoints to simplify the airspace reservation process and subsequently the trajectory conflict search. The global-to-local coordinate transformation performed by the control module 302 re-centers all mission waypoints with respect to the new origin, where the new origin represents the position of the aUAV at the time it contacts the control module 302. The control module 302 considers the waypoints and specifically only those that directly characterize the path through the reservation airspace. The control module 302 may calculate an expected path, including calculating a three-dimensional spline trajectory and interpolating the three-dimensional spline trajectory for each of the mission waypoints. The control module 302 may then make a reservation of voxels, where a voxel is one of multiple elements of volume, such as a flight path of a certain volume, that constitute a three-dimensional space representation. The control module 302 may determine whether two voxel reservation sets intersect.

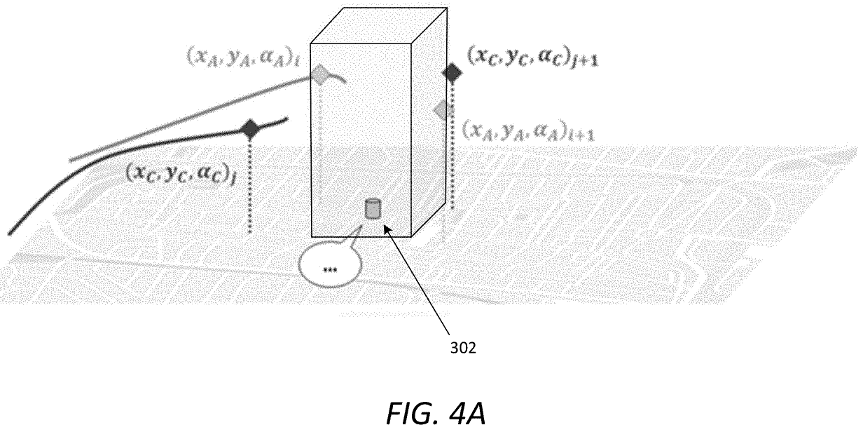

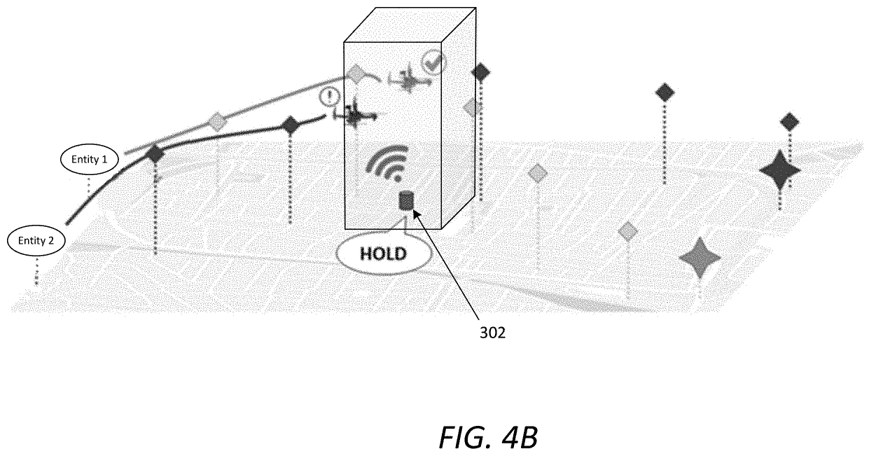

FIGS. 4A and 4B illustrate areas having overlapping or intersecting voxels. FIG. 4A shows the system performing trajectory conflict search and evaluation through voxel reservations. FIG. 4B shows an impending conflict triggering a hold command from the control module 302. In a situation such as that shown in FIGS. 4A and 4B, the control module 302 may broadcast a mandatory hold-in-place signal to one of the participants in the potential conflict, typically the one last entering the airspace, but the control module 302 may apply other rules. The one aUAV hovers in place until the other aUAV traverses the region safely, and the control module 302 may then transmit a “proceed” signal to the holing aUAV. Such operation decreases or eliminates the risk of in-air collision with minimal delay.

As recited herein, while certain determinations or calculations are said to be made by the control module 302, in actuality some or all of the calculations can be made by other components of the system, and some or all of the calculations or determinations may be made by processing components provided with or on the aUAV.

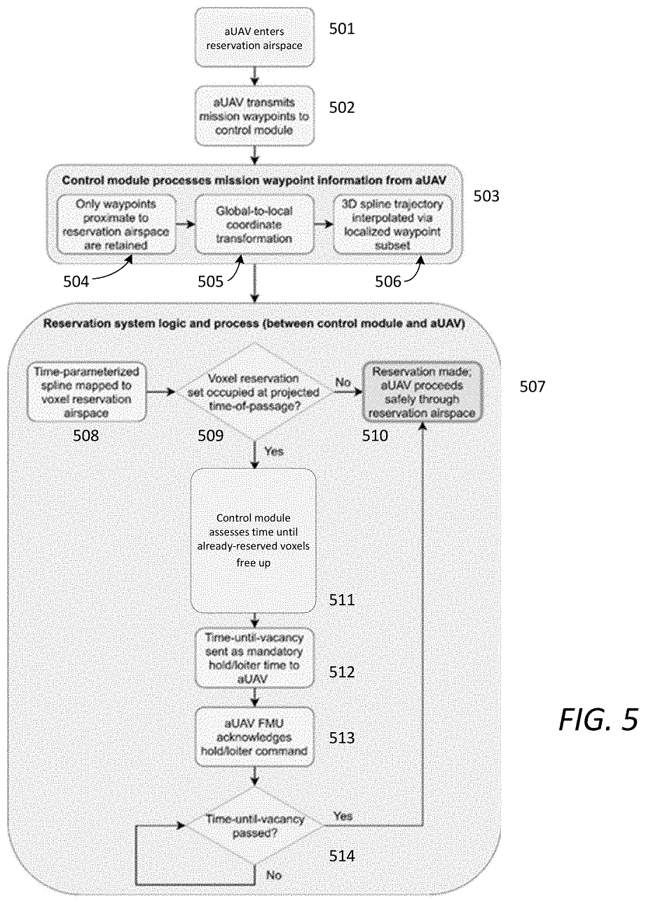

The workflow of the control module is shown in FIG. 5. From FIG. 5, the aUAV approaches and enters the reservation airspace at point 501, while at point 502 the aUAV transmits its mission waypoints to the control module. It should be realized that if the control module 302 is part of a network, waypoints may be requested and/or transmitted to the control module once the aUAV enters the airspace and is identified, such as by an identification number. For example, aUAV 1017 may enter the airspace of one control module, and the control module may transmit the number “1017” in some form to a central location, wherein the waypoints for aUAV 1017 are provided from a central database to the control module. Further, the aUAV may itself provide waypoint information. At point 503, the control module processes the mission waypoint information for the aUAV. From point 504, only waypoints proximate to the reservation space are retained or considered. For example, if a single waypoint is provided in the relevant airspace, the waypoint before and after the single waypoint are considered to make a full route through the airspace.

Thus in general, two more waypoints than are in the reservation space are considered such that a complete path through the reservation space can be determined and/or assessed. Point 505 indicates a potential global-to-local coordinate transformation, which may or may not be necessary, translating global waypoints such as those having GPS coordinates, to a usable set of coordinates. Simply put, point 505 translates, when necessary, waypoints into a format usable by the processing device, e.g. control module 302. Point 506 in this embodiment creates a 3D spline trajectory using interpolation of the localized waypoint subset. As may be appreciated, certain factors such as wind may result in uncertainty of the exact path, and thus a buffer or range of possible trajectories may be assessed. Conceptually, rather than a single line expressing a desired path, the path through the waypoints may resemble a tunnel or tube shape.

Point 507 represents the reservation system logic and processing as between the control module and the aUAV. Point 508 calls for the control module 302 and/or other device to determine a time-parameterized spline mapped to a voxel within the reservation airspace. Point 509 represents a determination as to whether the voxel representation set determined in point 508 is occupied at the projected time of passage. If not, as shown in point 510, the reservation is made or established, and the aUAV proceeds safely through the reservation airspace. If there is a conflict as determined at point 509, point 511 calls for the system to assess the time until the already reserved voxels become free. Again, such processing may occur at the control module 302 or may be performed using some processing of remote or centralized processing, control module processing, and/or aUAV onboard processing. Point 512 calls for transmitting the time-until-vacancy to the aUAV in the form of a mandatory hold or loiter time. Point 513 calls for confirmation from the aUAV that it has received the hold or loiter command, with which the aUAV is expected to comply. Finally, the system determines at point 514 whether the time-until-vacancy has passed. If not, the aUAV waits, and if the time-until-vacancy has passed, the system may proceed to point 510.

The present arrangement or embodiment is therefore that of a first-in, first-out (FIFO) arrangement. Other arrangements may be employed, and priorities or weightings employed to determine order, priorities, and paths.

One issue is the presence of more than one aUAV voxel in a given reservation airspace. For example, four paths may exist for four aUAVs entering a given reservation space controlled by a given control module. If this is the case, the system may perform the necessary mappings of point 508 and may make multiple determinations of hold or loiter times at point 511. For example, a fourth aUAV may enter a reservation space and its path may conflict with a first aUAV and a third aUAV as determined at points 508 and 509. The system may determine multiple loiter points for the fourth aUAV, which represents the last aUAV entering the airspace that is accorded the lowest priority. Points 512, 513, and 514 may be repeated, i.e. multiple hold/loiter times and positions for the fourth aUAV, for such a situation. In essence, the last aUAV into the reservation space must employ the necessary number of hold/loiter states or occurrences in this embodiment, while the preceding aUAVs entering the airspace continue about their paths, including their hold/loiter times.

The hardware and software that may be employed to effectuate the foregoing functionality are as follows. The onboard flight management unit (FMU) performs sensor fusion on the various sensor readings received from components such as the Global Positioning System (GPS) and inertial measurement unit (IMU). The onboard IMU combines an accelerometer, gyroscope, and magnetometer, all of which are calibrated prior to flight. The IMU provides local information regarding aUAV kinematics, as well as aUAV orientation with respect to the Earth's magnetic field. The GPS mainly serves to provide lateral localization. GPS data is provided in global latitude-longitude coordinates. Even though a three-dimensional location fix can be achieved via the GPS, altitude information is unreliable, and may be supplemented using a Light Detection and Ranging system (LiDAR). The LiDAR provides accurate altitude estimations by interpreting the point cloud data returns from the surface, converting that data into a distance-above-ground metric. The FMU utilizes all of these data sources to self-localize the aUAV with respect to global latitude-longitude coordinates, as well as an altitude above ground level.

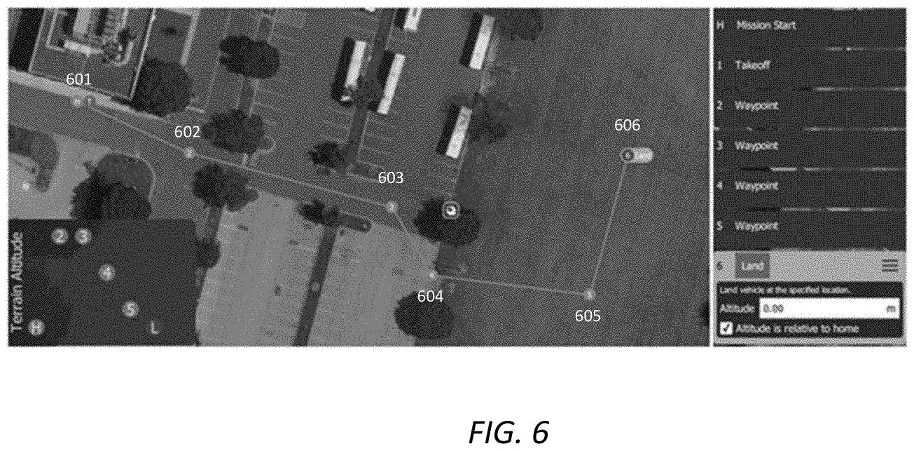

aUAVs for various missions may conduct initial mission and trajectory planning via interfaces. One candidate interface is QGroundControl (Dronecode). The interface may communicate with the aUAV FMU using any reasonably available communication channels and/or means, e.g. through a Universal Serial Bus connection or via telemetry on a standard 915 megahertz ISM band. In this embodiment, after the aUAV receives a mission profile, the connection does not need to be maintained for the aUAV to carry out the mission. Waypoints can be assigned from the interface; a sample mission assigned using QGroundControl is shown in FIG. 6. The sample mission begins at the home waypoint 601 and initiates the ascent to waypoint 2 602. The aUAV levels off and navigates from waypoint 2 602 to waypoint 3 603, before beginning a descent and final turn through waypoints 4 604 and 5 605. The mission concludes at waypoint 6 606 once the aUAV descends to a relative altitude of zero meters with respect to the home waypoint 601. A vertical profile of the mission is presented in the lower-left of FIG. 6, with a waypoint-by-waypoint summary on the right.

In order to deliver the necessary hold-in-place commands to an aUAV from the control module, the system may use an agent to communicate with the FMU onboard the aUAV to temporarily interrupt the ongoing mission of the aUAV. One example of such a device or agent is an ODROID XU4 microcontroller. The unit may receive power, such as via a USB-barrel power jack connection to a main power distribution hub of the aUAV. Other appropriate computing devices may be employed. Such an aUAV power supply may be mediated by a DC-DC converter that converts the high-voltage input from the power distribution hub into a steady 5-volt source supplying up to 6-amps in one configuration.

The agent may communicate with three entities: (1) the aUAV onboard FMU, (2) a receiver-transmitter unit, and (3) diagnostic services. The agent in this configuration may send hold-in-place commands and may interrupt the current mission being executed by the FMU. Actions sent to the FMU may be mediated by messages the agent receives from the receiver-transmitter unit.

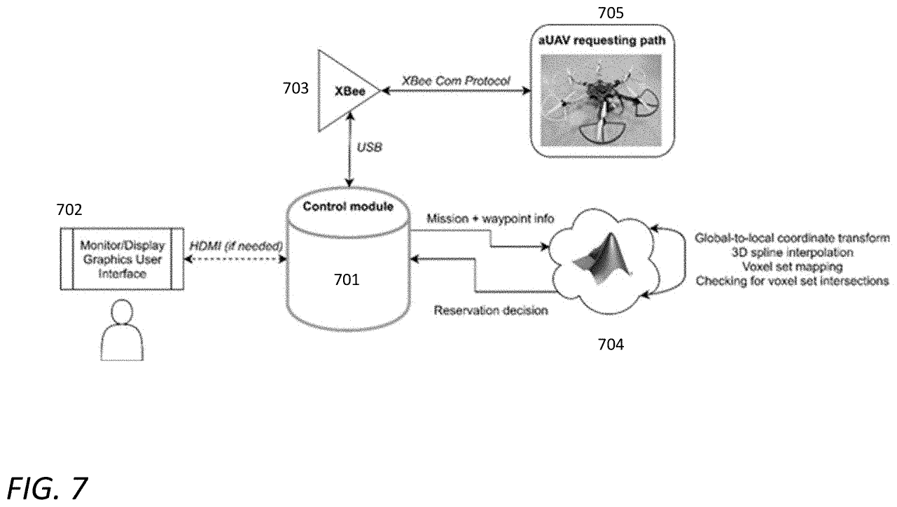

The control module may take different forms, but one example is a microcontroller that is preconfigured to continuously run a reservation system. One such microcontroller is a Raspberry Pi, and an example reservation system runs an appropriate language, such as MATLAB. The control module within the system is shown in FIG. 7. From FIG. 7, control module 701 is provided and communicates with monitor or display 702, and provides mission and waypoint information to a processing element 703 that may be internal or external to control module 701 that provides a global-to-local coordinate transformation, 3D spline interpolation, voxel set mapping, and checking for voxel set intersections, the result of which is provided back to control module 701. Control module 701 also transmits to a further processing element 704 that may simply be a computer software element or an architecture element that converts guidance data to the aUAV 705. Further processing element 704 in one instance may be an XBee communication link, wherein the second processing element 704 provides information to aUAV 705 via the XBee Com (or communication) protocol.

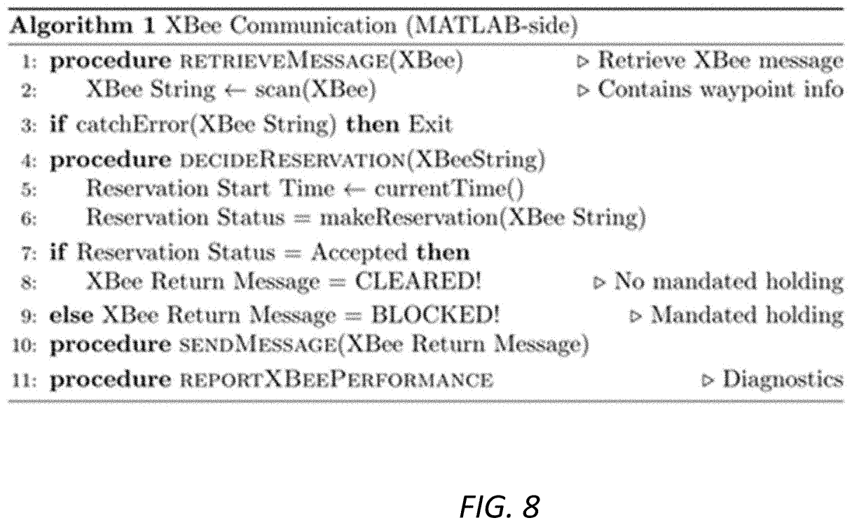

With respect to communication protocol between aUAV and control module, a lightweight protocol such as XBee may be employed to facilitate dialogue between the aUAV and the control module. The receiver and transmitter radio unit for XBee communication is small, light-weight, and can be connected via a USB-UART serial connection to both an ODROID onboard computer as well as the control module. Computer script within the control module that dictates the behavior of the XBee communication between the control module and the aUAV is given in FIG. 8. Prior to entering the reservation airspace, the ODROID onboard the aUAV broadcasts, in this embodiment, an XBee string via its onboard XBee receiver-transmitter unit. The complementary unit on the control module passively monitors its surroundings for a valid XBee string. When a valid XBee string is received by the control module, then the MATLAB reservation script parses the XBee string for relevant mission waypoint information as well as other metrics such as anticipated velocity through the reservation airspace. The reservation system employs this data to interpolate the spline trajectory, reserve the necessary voxel set, and determine whether or not such a reservation is acceptable or conflicts with one or more existing voxel sets. If the reservation is accepted, control module 701 sends back an “all-clear” signal, and the aUAV is allowed to pass. Otherwise, the control module 701 transmits a “blocked” signal. Such as via the XBee Com protocol to the aUAV XBee. The aUAV XBee may inform the onboard ODROID to inject a mandatory hold-in-place into the FMU, temporarily halting the mission.

Reservation airspace is not demarcated physically. The control module controls traffic movements through the reservation airspace by use of voxel reservation sets. The system constructs the reservation airspace and partitions the airspace into voxels that can be reserved by an aUAV seeking to traverse through this airspace. Each control module is responsible only for its own reservation airspace. Although the dimensions of the reservation airspace can vary, in practice reservation airspace is constrained by the communication range of the receiver-transmitter units.

In this arrangement, the system denotes the origin (0, 0, 0) to be the position of the control module c. The xy-plane is the ground surface, and positive z-axis denote the height above ground. The theoretical reservation airspace may be represented as a cube with length 2l meters centered at (0, 0, 0) with sides perpendicular or parallel to either the x-, y-, or z-axis. One face of the cube may lie in the xy-plane, with the rest of the cube projecting upwards in the positive z-direction. This cube is the reservation airspace belonging to control module c. A single voxel is the cube with side lengths m meters. The system may store each voxel of the reservation airspace in a matrix format. The total number of voxels N within this reservation system is shown in Equation 1:

$$N = {( \frac{2 l}{m} )}^{2} ( \frac{2 l}{m} - 1 ) \qquad ( 1 )$$

One such construct calls for initiating the control module with a corresponding reservation airspace of dimension 2l=30 meters, where each voxel is a m=1 meter cube, resulting in N=26,100 voxels for the reservation system within the control module.

Waypoints provided by the aUAVs are in global latitude-longitude coordinates. The system may, in one embodiment, utilize a global-to-local, latitude-longitude to Cartesian coordinates where the origin is the control module. Furthermore, since not all of the waypoints for a given mission received by the control module are necessary to create the reservation, only a specific subset of waypoint data is required. After coordinate transforming this subset of waypoints, the system constructs the requested path of the aUAV as a three-dimensional spline trajectory within the reservation airspace. The system “thickens” this spline trajectory to include position estimation errors and assigns the thickened spline trajectory to a specific set of voxels indexed in time.

The system subjects mission waypoint data to a global-to-local coordinate transformation from global latitude-longitude to local Cartesian with a new origin centered at the control module. Given global latitude-longitude coordinates (φ,λ) and the global latitude-longitude of the new origin (φₒ,λₒ), the system computes intermediary factors λₘ and φₘ via Equations 2 and 3, respectively.

λₘ=A_{λ} cos(α_{λ}λ)−B_{λ} cos(β_{λ}λ)+C_{λ} cos(γ_{λ}λ) (2)

φₘ=D−A_{φ} cos(α_{φ}φ)−B_{φ} cos(β_{φ}φ)+C_{φ} cos(γ_{φ}φ) (3)

The constants depend on the unit assigned to the Cartesian coordinate system post-transformation. In this case, the constants are specific to finalized results in meters. The local (x,y) coordinates in meters from the new origin corresponding to the given global latitude-longitude coordinates (φ,λ) and new origin (φₒ,λₒ) are given by Equations 4 and 5, respectively.

x=λₘ(λ−λₒ) (4)

y=φₘ(φ−φₒ) (5)

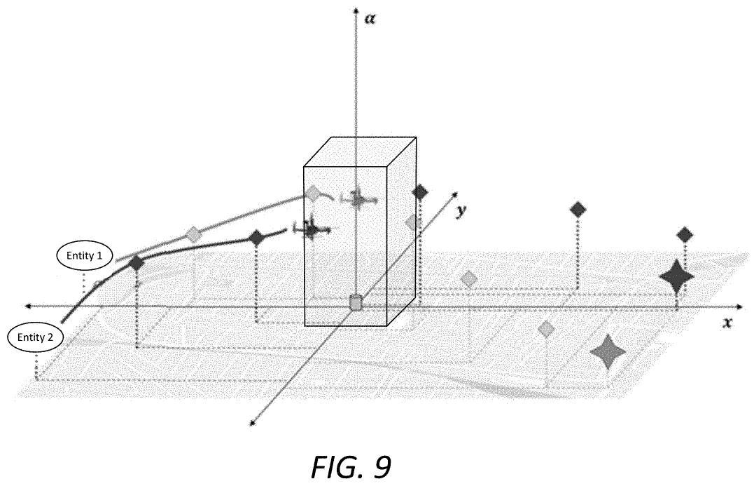

A visualization of this transformation can be seen in FIG. 9. One immediate simplification is obtaining the straight-line distance between the aUAV and the control module. In lieu of computing the orthodromic distance between the control module and the latitude-longitude coordinates of the aUAV, the system can simply compute the distance via the usual Euclidean norm on [symbol] ³.

After coordinate transformation, the control module subsets the list of waypoints received from the aUAVs by considering the waypoints inside of and immediately adjacent to the reservation airspace. Since the waypoints prior to and after the desired reservation airspace waypoints are outside the range of the control module, the control module in one embodiment may ignore those segments of the aUAV trajectory. This also reduces the amount of information that the control module has track per aUAV requesting a path through the reservation airspace. The processing required to interpolate a three-dimensional spline trajectory is also less burdensome.

The system as mentioned performs a three-dimensional spline trajectory interpolation. An aUAV wishing to enter the reservation airspace and reserving a set of voxels transmits n′ waypoints that comprise the mission to the control module. The system transforms all n′ waypoints to local Cartesian coordinates and identifies a subset of n′≤n waypoints, leaving a set of waypoints {\vec{p}₁, \vec{p}₂, . . . , \vec{p}ₙ}. The system characterizes each waypoint \vec{p}ᵢ=(xᵢ,yᵢ,αᵢ) by its coordinates in the local Cartesian space (xᵢ,yᵢ) as well as an altitude above ground αᵢ. The aUAV mission profile also typically contains the velocity at which the aUAV is expected to cross the reservation airspace. The system determines a time vector \vec{t}={t₁, t₂, . . . , tₙ} representing the approximate time at which each waypoint {\vec{p}₁, \vec{p}₂, . . . , \vec{p}ₙ} will be reached. The system denotes this time-augmented list of waypoints of interest as {\vec{p}₁, \vec{p}₂, . . . , \vec{p}ₙ}×\vec{t}={(\vec{p}₁, t₁), (\vec{p}₂, t₂), . . . , (\vec{p}ₙ, tₙ)}.

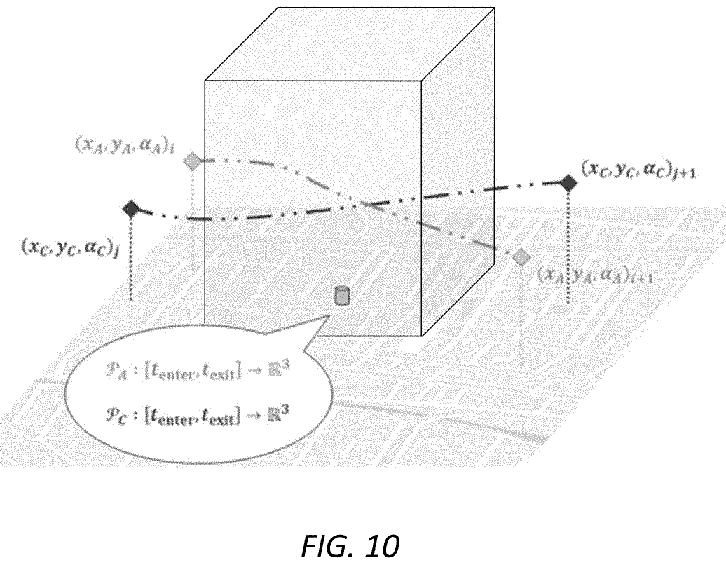

The system then seeks to interpolate a three-dimensional spline trajectory [symbol] : [t₁, tₙ]→ [symbol] ³ that estimates the position of the aUAV within the reservation airspace. One example of an interpolated set of paths is shown in FIG. 10, where the computed spline trajectory is given as dashed and dotted lines. A spline is continuous and differentiable where two differing segments join, and thus the trajectory of the aUAV and the positions of the waypoints are accounted for when computing the spline. The time segmentation scheme is as follows:

[t₁,tₙ]=[t₁,t₁+Δt]∪[t₁+Δt,t₁+2Δₜ]∪ . . . ∪[tₙ−Δt,tₙ] (6)

The system breaks up the time interval [t₁, tₙ] into an arbitrary number of segments, potentially depending on obstacles (trees, buildings, etc.), and the Δt time increment depends on the number of segments produced. The spline trajectory is defined as:

[symbol]

(t)={ [symbol] ₓ(t), [symbol] _{y}(t), [symbol] _{z}(t)} (7)

Each individual spline [symbol] _{{x,y,α}}(t) describes the x-, y-, or α-position of the aUAV at time t. One embodiment of the system includes cubic splines, resulting in [symbol] _{{x,y,α}}(t) as shown in Equations 8 and 9:

[symbol]

_{{x,y,α}}(t)≡ [symbol] _{{x,y,α},l}(τ)=aₗ+bₗτ+cₗτ²+dₗτ³ (8)

τ=(t−l)∈[0,Δt] (9)

The system takes these n waypoints with N intervals and uses boundary derivative conditions on these cubic spline polynomials to rewrite the coefficients in Equation 8 in terms of common terms. This system of equations is given in Equations 10, 11, 12, and 13:

aᵢ=jᵢ (10)

bᵢ=Dᵢ (11)

cᵢ=3(jᵢ₊₁−jᵢ)−2Dᵢ−Dᵢ₊₁ (12)

dᵢ=2(jᵢ−jᵢ₊₁)+Dᵢ+Dᵢ₊₁ (13)

This system of linear equations can be rewritten in matrix form A\vec{x}=\vec{b}. Furthermore, due to the special properties of these cubic polynomials that arise from this interpolation scheme, the large coefficient matrix A ends up being a tridiagonal matrix. This lends itself to fast computation of the inverse for A, and the system determines the result \vec{x}=A⁻¹\vec{b}.

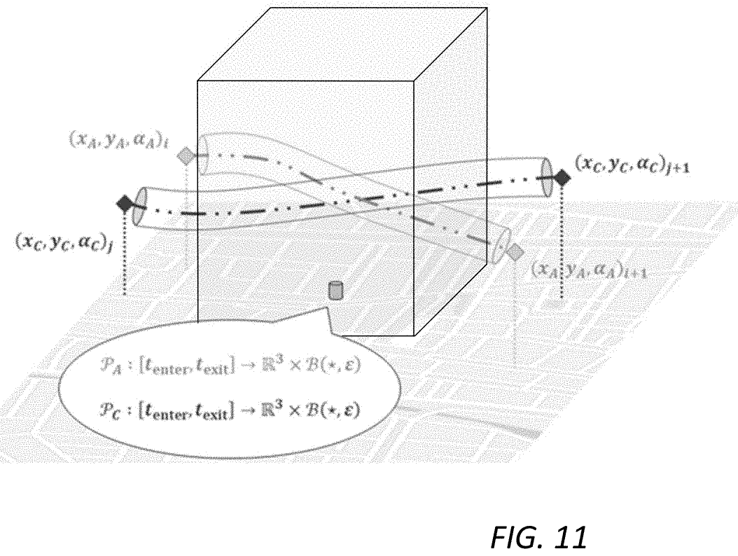

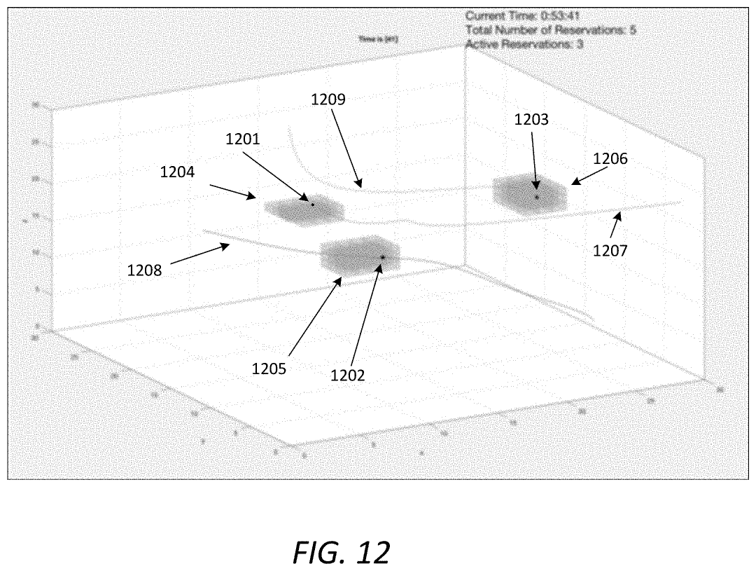

Due to positional inaccuracies arising from the GPS, the system assigns a measure of uncertainty to the aUAV position given by the interpolated spline trajectory to compensate for GPS issues, wind, or other factors encountered in such situations. The system attaches a disc [symbol] (*, ε)⊂ [symbol] ² centered on each evaluation * := [symbol] (tᵢ), tᵢ∈[t₁, tₙ] of the spline trajectory with preset error radius ε>0. The plane of the error disc is orthogonal to the spline path, where the spline path represents a “thickened” spline trajectory with a surrounding tubular error neighborhood. A representation of one embodiment is shown in FIG. 11. FIG. 11 illustrates “thickened” spline trajectories with tubular error neighborhoods of radius ε>0 attached. Such tubular error neighborhoods may vary in size, and may not be uniform through an entire region. Factors such as wind or other turbulence expected within the region may be employed in determining size of the tubular error neighborhoods. In one embodiment, a value of 1.0 meters (diameter) is provided, but other values may be provided depending on conditions. As one example, a windy region may call for a 2.0 meter or more diameter, while traversing a climate controlled region may justify a smaller value. The dimensional value of the tubular error neighborhood for a spline path translates to reserving every adjacent voxel as well as the voxel containing the evaluation [symbol] (tᵢ). One representation of voxels, and proximate areas for traversing voxels, is shown in FIG. 12. FIG. 12 represents three splines traversing a region controlled by a control module. aUAVs 1201, 1202, and 1203 are represented as dots, whereas the reserved voxels 1204, 1205, and 1206 at this time instant are highlighted as boxes. Interpolated spline trajectories 1207, 1208, and 1209 are also shown.

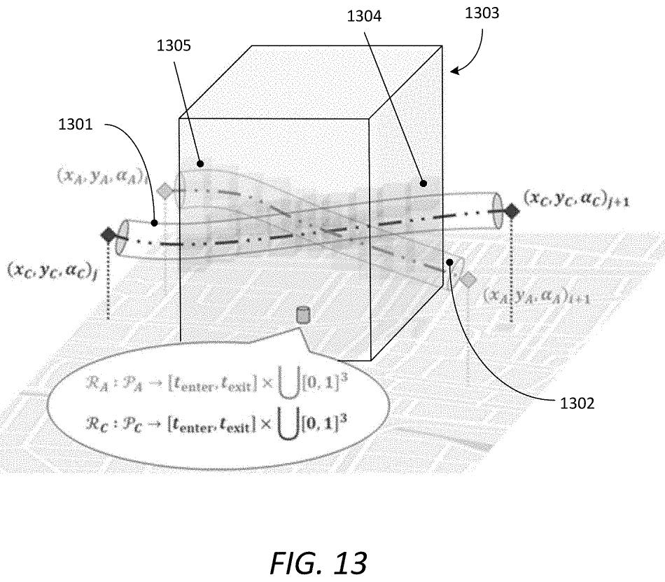

FIG. 13 illustrates one embodiment of the present design with “thickened” spline trajectories 1301 and 1302 mapped into the voxel partitioned reservation airspace 1303. The first thickened spline 1301 is assigned a first voxel reservation set 1304 while the second thickened spline 1302 is assigned a second voxel reservation set 1305. Calculations made by the control module are shown.

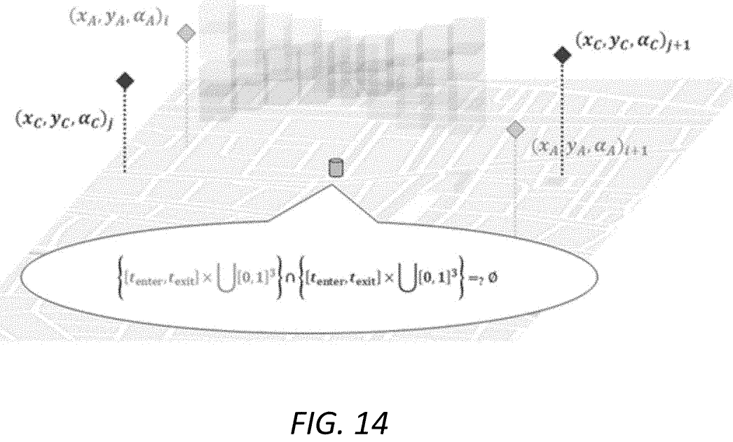

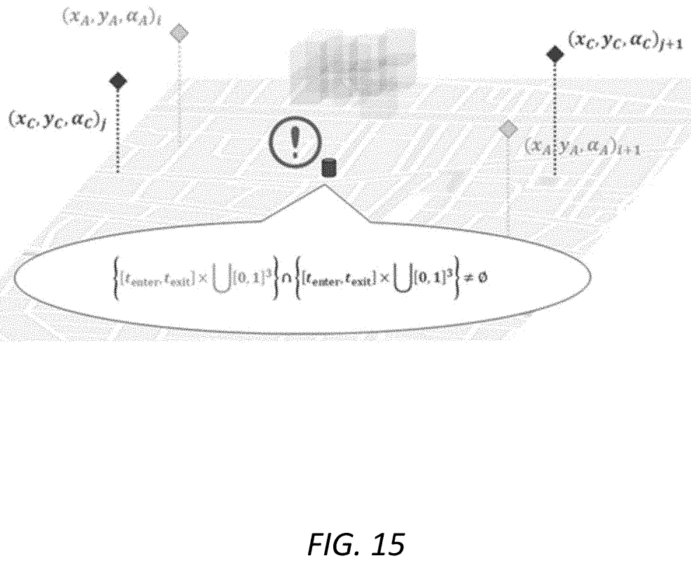

FIG. 14 shows the system searching for intersections between two voxel sets. In essence, the voxels are compared according to the calculations shown, and overlapping voxel regions indicate an issue. FIG. 15 illustrates two overlapping areas, indicating a conflict. The system then controls the situation according to non-contact rules. For example, the control module transmits a command to the last-entering aUAV to hold in place until the earlier entering aUAV passes. Alternately, a priority may be accorded to the aUAVs, and the lower priority aUAV commanded to hold in place. Other arrangements may be provided as desired, with the command module issuing hold commands as required. Further, in one embodiment, an aUAV may be commanded to traverse to a specified “safe” location and hold there, and once the conflict has resolved, such as by the conflicting aUAV traversing through a conflicting area, the holding aUAV may be commanded to leave the “safe” location and recommence its travel to the next waypoint. Such functionality may be beneficial when and if an aUAV would otherwise be commanded to hold its flight in a problematic area, such as an area where aUAVs have been downed, or areas where birds frequent, or simply an area where a great deal of wind or turbulence is believed present and the “safe” location does not have such drawbacks or issues.

The present communications may be restricted in certain instances, such as by providing aUAVs with waypoint information via hard wire rather than wireless transmission. Further, information about an aUAV entering the region or airspace may be provided via hard wire from a centralized control arrangement, such as a central group of servers monitoring and interfacing with multiple control modules. In the case of communications between the control module and an aUAV entering its region, such communications may be encrypted, password protected, or otherwise secured such that the communications cannot be readily intercepted, nor improper commands provided to aUAVs in the region.

While the present system has been described using transmission of a “hold in place” command to an aUAV when a conflict exists and a subsequent “resume travel” command to that aUAV when the conflict is resolved, it is to be understood that the design is not so limited. For example, such commands may be transmitted to the higher priority aUAV, or alternately the command sent may be a command other than hold-in-place, such as change altitude, change path to path X, or otherwise, and commands may be provided to more than one aUAV. For example, the system may transmit a “raise altitude 100 feet” to one aUAV in a region, and “lower altitude 10 feet” to a second aUAV in the region, and may subsequently transmit a “resume travel” or “reacquire and resume path” command to both, or may transmit alternate waypoints to one or more aUAVs. In all, when a conflict is encountered, the system determines the conflict and transmits commands to at least one aUAV to alter course and avoid the conflict. At a later time, a second command may be transmitted to at least one aUAV representing a “resume travel (according to desired path protocol)” such that each aUAV may proceed with minimal threat of conflict. Further, the system may sense changes in the environment and may provide commands accordingly. For example, if the system obtains information that a large object has been temporarily placed in the path of an aUAV, the system may transmit a command to hold-in-place or maneuver to avoid the object. Other command and control scenarios may be employed while within the teachings of the present system.

Thus according to the present design, there is provided a system for controlling flight paths of a plurality of autonomous unmanned aerial vehicles (aUAVs), comprising a control module located within a region, the control module comprising a receiver-transmitter configured to receive waypoint information from aUAVs entering the region and transmit navigation commands to each aUAV in the region, and one processing element added to and provided with one aUAV configured to enter the region, the one processing element added to and provided with the one aUAV configured to transmit waypoint information for a desired path for the one aUAV through at least one waypoint in the region to the control module. The control module is configured to transmit a first command to the one processing element of a lower priority aUAV in case of a path conflict in the region between the lower priority aUAV and a higher priority aUAV and a second command to the lower priority aUAV upon resolution of the path conflict.

According to another aspect of the present design, there is provided a system for controlling autonomous unmanned aerial vehicles (aUAVs), comprising a control module located within a region, the control module comprising a receiver-transmitter configured to receive waypoint information from aUAVs entering the region and transmit select navigation commands to select aUAVs in the region, and one processing element added to and provided with one aUAV configured to enter the region, the one processing element configured to transmit waypoint information for a desired path for the one aUAV through at least one waypoint in the region to the control module. The control module is configured to determine conflicts between aUAV paths and transmit a first command to the one processing element of a lower priority aUAV in case of a path conflict in the region between the lower priority aUAV and a higher priority aUAV and a second command to the lower priority aUAV upon resolution of the path conflict.

According to a further embodiment, there is provided a system for controlling autonomous unmanned aerial vehicles (aUAVs), comprising a control module located within a region, the control module configured to receive waypoint information from aUAVs entering the region and transmit select navigation commands to select aUAVs in the region, and one processing element added to and provided with one aUAV configured to enter the region, the one processing element configured to transmit waypoint information for a desired path for the one aUAV through at least one waypoint in the region to the control module. The control module is configured to transmit a first command to the one processing element of a lower priority aUAV in case of a path conflict in the region between the lower priority aUAV and a higher priority aUAV and a second command to the lower priority aUAV upon resolution of the path conflict.

Although the present invention has been described in considerable detail with reference to certain preferred embodiments, other embodiments are possible. The steps disclosed for the present methods, for example, are not intended to be limiting nor are they intended to indicate that each step is necessarily essential to the method, but instead are exemplary steps only. Therefore, the scope of the appended claims should not be limited to the description of preferred embodiments contained in this disclosure. All references cited herein are incorporated by reference in their entirety.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for controlling flight paths of a plurality of autonomous unmanned aerial vehicles (aUAVs), comprising:
a control module located within a region, the control module comprising a receiver-transmitter configured to receive waypoint information from aUAVs entering the region and transmit navigation commands to each aUAV in the region; and
one processing element added to and provided with one aUAV configured to enter the region, the one processing element added to and provided with the one aUAV configured to transmit waypoint information for a desired path for the one aUAV through at least one waypoint in the region to the control module;
wherein the control module is configured to transmit a first command to the one processing element of a lower priority aUAV in case of a path conflict in the region between the lower priority aUAV and a higher priority aUAV and a second command to the lower priority aUAV upon resolution of the path conflict.

2. The system of claim 1, wherein the control module comprises a control module processing element configured to determine aUAV conflicts between multiple aUAVs that enter the region and transmit a hold-in-place command to the lower priority aUAV based on the determination.

3. The system of claim 2, wherein the control module determines times each aUAV traverses waypoints in the region and determines the conflict based on paths through the region and times aUAVs will be in a particular region.

4. The system of claim 2, wherein the control module processing element computes a spline representation of a desired path for each aUAV traversing the region.

5. The system of claim 4, wherein the control module processing element computes a thickened spline trajectory for each waypoint traversing spline path, the thickened spline trajectory comprising a nonzero tubular error neighborhood around each spline representation.

6. The system of claim 5, wherein size of the nonzero tubular error is determined based on conditions expected by one aUAV along the path of the one aUAV within the region.

7. The system of claim 1, wherein the system comprises multiple control modules geographically distributed within different regions.

8. The system of claim 1, wherein a remote device arrangement determines aUAV conflicts between multiple aUAVs that enter the region and provides the determination to the control module, which transmits a hold-in-place command as the first command based on the remote device arrangement determination and subsequently transmits a resume travel command as the second command.

9. A system for controlling autonomous unmanned aerial vehicles (aUAVs), comprising:
a control module located within a region, the control module comprising a receiver-transmitter configured to receive waypoint information from aUAVs entering the region and transmit select navigation commands to select aUAVs in the region; and
one processing element added to and provided with one aUAV configured to enter the region, the one processing element configured to transmit waypoint information for a desired path for the one aUAV through at least one waypoint in the region to the control module;
wherein the control module is configured to determine conflicts between aUAV paths and transmit a first command to the one processing element of a lower priority aUAV in case of a path conflict in the region between the lower priority aUAV and a higher priority aUAV and a second command to the lower priority aUAV upon resolution of the path conflict.

10. The system of claim 9, wherein the control module comprises a control module processing element configured to determine aUAV conflicts between multiple aUAVs that enter the region and transmit a hold-in-place command as the first command based on the determination.

11. The system of claim 9, wherein the control module determines times each aUAV traverses waypoints in the region and determines the conflict based on paths through the region and times aUAVs will be in a particular region.

12. The system of claim 9, wherein the control module processing element computes a spline representation of a desired path for each aUAV traversing the region.

13. The system of claim 12, wherein the control module processing element computes a thickened spline trajectory for each waypoint traversing spline path, the thickened spline trajectory comprising a nonzero tubular error neighborhood around each spline representation.

14. The system of claim 13, wherein the control module processing element determines size of the nonzero tubular error based on conditions expected by one aUAV along the path of the one aUAV within the region.

15. The system of claim 9, wherein the system comprises multiple control modules geographically distributed within different regions.

16. A system for controlling autonomous unmanned aerial vehicles (aUAVs), comprising:
a control module located within a region, the control module configured to receive waypoint information from aUAVs entering the region and transmit select navigation commands to select aUAVs in the region; and
one processing element added to and provided with one aUAV configured to enter the region, the one processing element configured to transmit waypoint information for a desired path for the one aUAV through at least one waypoint in the region to the control module;
wherein the control module is configured to transmit a first command to the one processing element of a lower priority aUAV in case of a path conflict in the region between the lower priority aUAV and a higher priority aUAV and a second command to the lower priority aUAV upon resolution of the path conflict.

17. The system of claim 16, wherein the one processing element comprises an ODROID onboard computer and the control module communicates with the ODROID onboard computer via an XBee communication protocol.

18. The system of claim 16, wherein priority is determined based on a first-in, first out protocol.

19. The system of claim 16, wherein the system performs a global latitude-longitude to local Cartesian transformation on the waypoints for at least one aUAV configured to enter the region.

20. The system of claim 16, wherein the system computes a path for each aUAV based on all waypoints within the region and at least one waypoint outside the region.
